(19) United States
(12) Patent Application Publication
(10) Pub. No.: US 2011/0089751 A1
(43) Pub. Date: Apr. 21, 2011

(54) COMPOSITE RIM AND A WHEEL HAVING SUCH RIM

(75) Inventor: Benoít SAILLET, Albens (FR)

(73) Assignee: SALOMON S.A.S., Metz-Tessy (FR)

(21) Appl. No.: 12/904,612

(22) Filed: Oct. 14, 2010

(30) Foreign Application Priority Data
Oct. 15, 2009 (FR) 09.04951

(51) Int. Cl. B60B 5/02; B60B 1/02

(52) U.S. Cl. 301/95.103; 301/64.702

(57) ABSTRACT

A cycle rim that includes a metallic profile element, a covering made of composite material and including fibers embedded in a first matrix that covers the metallic profile element, at least over a portion thereof, and further including a spacer which is inserted between the profile element and the covering. The metallic profile element includes at least two sidewalls connected by a bridge, the covering including at least two flanks, each of the flanks covering one of the sidewalls, and the spacer is inserted between each of the sidewalls and the flank which covers it.

### CROSS-REFERENCE TO RELATED APPLICATION

This application claims priority under 35 U.S.C. §119 of French Patent Application No. 09 04951, filed on Oct. 15, 2009, the disclosure of which is hereby incorporated by reference thereto in its entirety.

### BACKGROUND OF THE INVENTION

1. Field of the Invention

The invention relates to a rim for a spoked wheel, in particular a rim for a spoked wheel of a bicycle. The invention also relates to a wheel including such a rim.

2. Background and Other Information

In a known fashion, a bicycle rim has an at least partially box-shaped annular profile element, i.e., such as an annular element having a constant cross-sectional shape, which includes one or two bridges, i.e., a lower bridge and an upper bridge, respectively; as well as two sidewalls connected by the bridge(s), the sidewalls extending radially outwardly to form a pair of transversely opposed flanges, the flanges forming, with the upper bridge, a channel for receiving the tire, with the flanges having lips for fastening the tire. The rim is connected to a hub by means of spokes which are fastened to the lower bridge.

Rims are generally made by using a metallic profile element, typically extruded, and are generally made of light but strong material such as an aluminum alloy or the like.

Moreover, rims are known to have a covering made of composite material, with a tapered transverse cross section decreasing progressively from the base of the metallic profile element in a direction toward the hub.

In the case of this known rim, the covering fulfils an aerodynamic role and contributes partially to the stiffening of the rim. The covering is fixed, for example, by adhesive on the sidewalls of the metallic profile element, over a portion of the height thereof, the top of the profile element remaining uncovered to provide metallic braking surfaces adapted to cooperate with the brakes of the bicycle, braking on composite material surfaces being widely known to be less effective.

Given that the covering contributes little to the stiffening of the rim, it can be made with sufficient flexibility so that it can deform and be assembled onto a metallic profile element, which is premade and consequently non-deformable.

A mixed metal/composite rim construction is also known from the U.S. Pat. No. 5,975,645, in which a metallic profiled element having a single bridge is extended, in cross section, in the direction toward the wheel axle in the form of a bulbous body made of composite material. This composite material body is fixed by adhesive on the lower surface of the bridge of the metallic profile element. In this embodiment, the composite material body contributes to the stiffening of the rim, and the sidewalls of the metallic profile element are used for braking.

The purpose of this construction is to resist the substantial heat emissions caused by braking, in particular in the case of so-called mountain bikes (MTB), and to remedy the problems related to braking on surfaces made of mixed steel/carbon materials having very different coefficients of expansion with respect to one another.

Furthermore, because the covering is premade in a single piece and is non-deformable, it would not be possible to assemble it by adhesive onto a metallic profile element that is also non-deformable. For this reason, in the method described, the metallic profile element, which is previously bent into the shape of a wheel but without its two ends yet connected to each other, and therefore deformable, is positioned first around the composite covering before its two ends are connected.

The document FR 2898541 describes another type of mixed metal/composite rim construction, in which a composite material covering rises along the sidewalls of the metallic profile element in order to hide the sidewalls completely and to give the illusion of a rim made entirely out of composite material. In this type of construction, braking occurs against a mixed wall of the rim, i.e., a wall including an aluminum layer covered with a composite layer. The composite material covering is fixed onto the metallic profile element by adhesive at the time the composite portion is being polymerized, the metallic profile element being positioned in the polymerization mold of the composite portion at the same time as the remaining components. This solution involving adhesive by polymerization raises serious problems with respect to the adhesive hold over time, especially for this particular type of rim. Indeed, the resin used for polymerizing the composite and for bonding the fibers of the composite to one another then carries out an additional function, which is to bond the composite covering to the metallic profile element. However, this additional function is considerably necessary throughout the life of the product, during braking phases. The thermal energy generated during braking, over time, damages the bond between the metallic profile element and the composite covering.

It is also known to have rims made entirely out of carbon; these rims are generally not adapted for use with nontubular tires (i.e., clincher tires) because it is difficult, with composite material, to obtain profile elements with connection zones having isotropic strength for fastening the tires. Such rims are therefore generally reserved for use with tubular tires. Of course, it would be possible to make such rim entirely out of carbon, with zones reinforced with additional carbon layers in order to increase strength under the stress of inflation. However, such rims would be heavier, whereas the use of carbon is advantageous with respect to other less expensive materials, in part for its lightweight.

### SUMMARY

The invention provides a rim that that overcomes the disadvantages of the prior art.

The rim of the invention is as light in weight as possible, but also has a good aerodynamic profile, i.e., an aerodynamic shape.

In addition, the rim of the invention is compatible for both tubular and nontubular tires.

The invention also provides a method of manufacturing a bicycle rim, in which a non-deformable metallic profile element is premade, and then positioned in a mold with the various components of the composite covering (fibers, resin).

The invention also provides a rim combining a metallic profile element and a composite covering, in which braking, i.e., the contact of the brake pads with the rim, is carried out on the covering which has improved stability over time.

All of the foregoing aspects of the invention are achieved in a rim according to the invention, the rim being of the type that includes a metallic profile element and a composite material covering fixed on each of the sidewalls of the profile element, substantially over the entire height of the sidewalls, with the composite covering comprising a plurality of fibers embedded in a matrix that constitutes a first resin; and wherein the rim includes an adhesive including a substance different from that of first resin and adapted to provide a bond between the metallic profile element and the composite covering.

These aspects of the invention are also achieved by providing a bicycle rim having a metallic profile element; a composite material covering comprised of fibers embedded in a matrix that covers the metallic profile element, at least over a portion thereof; the rim further comprising a spacer inserted between the profile element and the covering.

In a particular embodiment of the invention, the metallic profile element comprises at least two sidewalls connected by a bridge and the covering comprises at least two sides, each of the sides covering a respective one of the sidewalls, wherein the spacer is inserted between each of the sidewalls and the side that covers it.

In another embodiment of the invention, the spacer is put in contact with the two sidewalls and the bridge of the profile element.

According to another embodiment, the covering is comprised of high performance fibers embedded in a first resin.

In a particular embodiment, the spacer has a thickness ranging between 0.05 mm and 0.2 mm; the spacer can be comprised of fibers or balls embedded in a second resin. The second resin can be different from or identical to the first resin.

A rim is thus produced that has the external appearance of a rim made completely out of carbon, while being compatible for use with tires, such as clincher tires (i.e., nontubular tires), because the metallic profile element can comprise, on its sidewalls, adequate attachment zones for fastening the tires.

Furthermore, the composite material that rises along the sidewalls of the metallic profile element contributes to the mechanical strength of the profile element and in particular makes it possible to increase its strength and that of the attachment zones with respect to the stresses incurred during tire inflation, in the case of a rim for clincher tires. This makes it possible to optimize the weight of the metallic profile element and, therefore, that of the rim as a whole. Furthermore, the configuration of the profile element defines a predetermined configuration of the rim in the braking zone, and it has been surprisingly determined that this configuration makes it possible to improve the braking quality substantially, compared to known rims that are entirely composite.

The foregoing aspects of the invention are also achieved by providing a cycle, such as a bicycle, and a wheel comprising a rim as described above.

### BRIEF DESCRIPTION OF THE DRAWINGS

Other characteristics and advantages of the invention will be better understood from the description that follows, with reference to the annexed drawings illustrating, in a non limiting fashion, how the invention can be embodied, and in which:

FIG. 1 is a perspective view of a wheel according to the invention,

FIG. 2 is a cross-sectional view of a rim according to an embodiment of the invention, and

FIG. 3 is a detailed view of the rim shown in FIG. 1.

### DETAILED DESCRIPTION

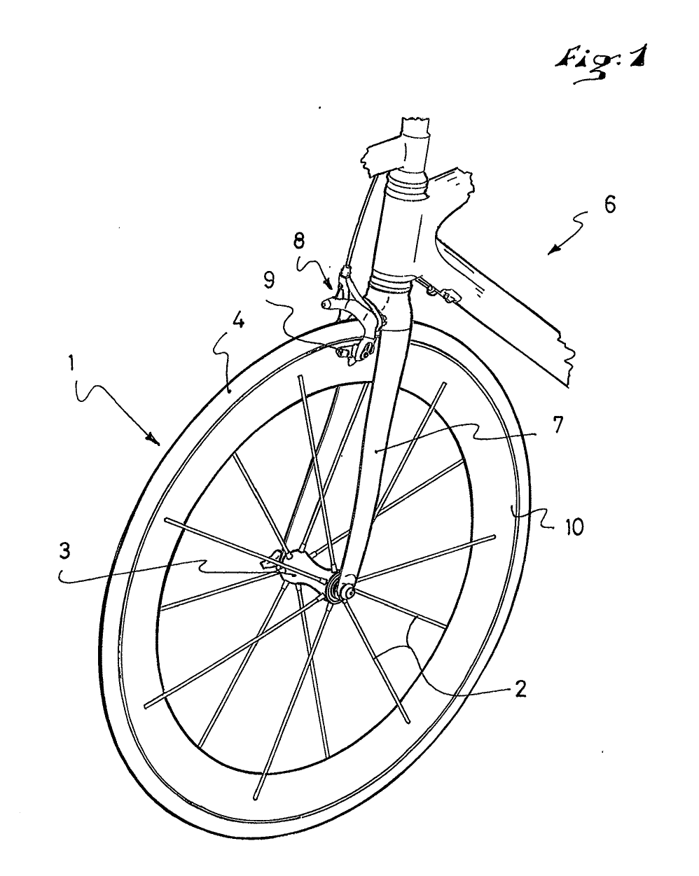

FIG. 1 is a partial view, in perspective, of a cycle, i.e., a bicycle, equipped with a wheel according to the invention. The bicycle 6 includes, among other things, a front fork 7 between the blades of which a wheel 1 is mounted. In a known configuration, the wheel 1 includes a peripheral rim 10 and a central hub 3. A plurality of spokes 2 are arranged between the hub 3 and the rim.

The bicycle 6 also includes a braking device which distributes the braking force on the front wheel 1 and the rear wheel (not shown). The front brake 8 functions by application of two pads 9 against the rim 10. Each of the two pads is mounted at the end of a pivoting stirrup. An actuation by cable, controlled from the handlebar by means of a lever, causes the stirrups to pivot so as to press the pads 9 against the rim 10. The portions of the side surfaces of the rim against which the pads are applied are called the braking surfaces, or flanks, 33. The braking flanks constitute the outer side surfaces of the rim over a height “h” ranging between 6 mm and 12 mm, or, in more particular embodiments, between 8 mm and 10 mm.

The flanks 33 are substantially planar annular surfaces, parallel to the plane of the wheel, the median plane being the plane of symmetry of the wheel, perpendicular to the axis of rotation of the wheel. In certain cases, the braking surfaces can form a very small angle with the median plane, in which case the flanks are not rigorously planar but form truncated surfaces.

The flanks 33 are located in the zones farthest away from the axis of the wheel, in the vicinity of the tire.

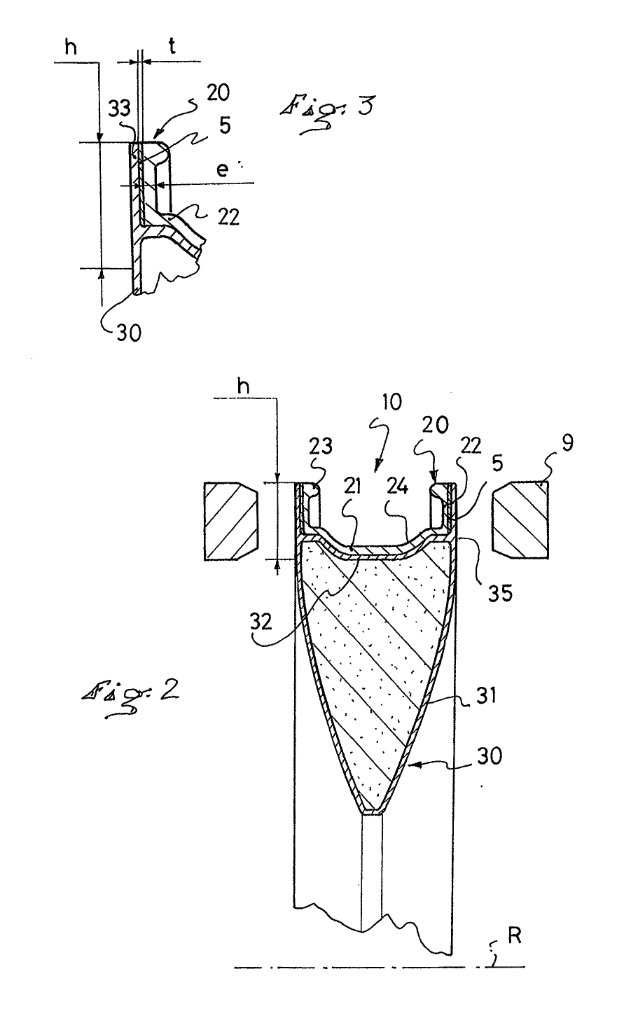

FIG. 2 shows a cross section of the rim 10 according to the invention. The rim 10, which conventionally has an annular shape, comprises a metallic profile element 20, such as an annular element having a constant cross-sectional shape, and a covering 30 made of composite material. The rim is adapted to be used with a wire bead tire, i.e., a clincher tire (i.e., a nontubular tire). This is not a limitation on the scope of the invention, because the invention can also be implemented for rims adapted to receive tubular tires.

The metallic profile element 20 has a substantially U-shape, in cross section, open radially outwardly of the rim, and comprises a bridge 21 that is substantially horizontal in the drawing, i.e., substantially parallel to the rotational axis R of the rim. In the example shown, the bridge 21 is not completely rectilinear and has a hollow portion 24, or recess, in its median zone. Alternatively, the bridge 21 could be rectilinear. The metallic profile element 20 further comprises two sidewalls 22, substantially vertical in the drawing and extending substantially perpendicular to the bridge 21 or to the axis R. The two sidewalls 22 are therefore substantially parallel to one another and are connected to one another by the bridge 21. It is in the area of these two sidewalls that the brake pads are applied.

Each of the sidewalls 22 has, at its free end, a lip 23, or hook, which, in a known manner, enables a tire (not shown in the drawing) to be fastened. The metallic profile element 20 is made by extrusion, after which it is bent to form the desired annular shape. The metallic profile element is made of light-weight metallic alloy having great mechanical strength properties, and, in an exemplary particular embodiments, is made of aluminum, magnesium, or high-grade steel alloy.

The covering 30, made of composite material in the illustrated example, has a substantially V-shape comprising, in cross section, two fixed arms 31 covering respective ones of the sidewalls 22, over substantially the entire height of the sidewalls, including in the braking zone of the flanks 33 (see the brakes 9 shown schematically in FIG. 9), and then extending downwards, i.e., in the direction of the rotational axis R of the rim, while connecting to one another to form the V.

The composite material covering 30 also comprises a substantially horizontal portion 32 that covers the lower surface of the bridge 21 (i.e., the radially inward surface of the bridge) of the metallic profile element.

The covering 30 is comprised of a mixture of a first resin, such as epoxy resin, for example, and fibers, such as carbon fibers, glass fibers, Kevlar®, etc., for example. In a particular embodiment, the covering 30 is made with high performance fibers, which associate a very high Young's modulus for a reasonable weight. In practice, carbon fibers, possibly boron fibers, can be used.

Due to its V-shape, the covering 30 confers a greatly advantageous aerodynamic shape on the rim.

Furthermore, the covering 30 also contributes to the mechanical strength of the rim and to the mechanical strength of the metallic profile element 20 as a whole, as well as in the area of the sidewalls 22 and in the area of the bridge 21. Depending upon the material used for the metallic profile element and/or the thickness thereof, the portion 32 of the covering 30 can be omitted in a particular alternate embodiment.

By rising along the entire height of the sidewalls 22, the covering 30, 35 makes it possible to increase the strength of the profile element in the hooking zone, i.e., in the area of the lips 23, and thus makes it possible to increase the resistance of the profile element to the stress generated during tire inflation, by opposing the opening of the profile element under the effect of tire inflation.

This construction thus makes it possible to reduce to the maximum the size of the metallic profile element, which here comprises only one bridge, and thus to optimize to the maximum the weight of the metallic profile element/composite material assembly. In practice, the metallic profile 20 can be provided so that its height h does not exceed a value of 10 mm, even with a so-called thin profile element, i.e., one whose walls have a 0.7 mm thickness, or substantially a 0.7 mm thickness.

Furthermore, contrary to generally accepted ideas, the fact that the carbon covering 30 rises into the braking zone, and thereby constitutes the braking flanks 33, does not penalize, or adversely affect, the braking itself, because the metallic profile element fixed below, and in this case its sidewalls 22, guarantees the configuration of the braking zone, such as the flatness of the braking surfaces, for example.

According to the invention, as shown in FIG. 3, a spacer 5 is inserted between the metallic profile element 20 and the covering 30. In the embodiment illustrated here, a spacer 5 is positioned against each of the sidewalls 22 of the profile element 20, in the area of the braking flanks 33. The spacer 5 is made of a different material than that used for the covering 30 and that used for the metallic profile element 20. A material can be selected that does not couple, or that very slightly couples, electrolytically with aluminum. However, it is important to select a material that well resists the heat and pressure cycle of polymerization.

In the illustrated exemplary embodiment, the spacer can be made by embedding glass balls in a second resin, or an adhesive resin, or by using glass fibers or polyester fibers also placed in a resin matrix. The thickness “t” of the spacer 5 is relatively small. In practice, the thickness “t” can range between 0.05 mm and 0.2 mm.

The second resin, i.e., the adhesive resin, is different from the first resin, so-called stratification resin, which is used to make the covering 30. It is however necessary to ensure viscosity compatibility between the adhesive resin and the stratification resin, in particular to prevent the stratification resin from driving out an overly fluid adhesive resin. In practice, resins are selected whose viscosity curves (rheology) are close to each other. The presence of the adhesive resin in a sufficiently large space in the zone separating the profile element from the covering is guaranteed by the spacer 5.

If the profile element is made of aluminum alloy, an adhesive resin having good adhesive properties against aluminum is used, for example a resin having a strength greater than 30 MPa at room temperature and strictly greater than 15 MPa at 100° C., on a shear adhesion test of the EN 2243-1 type.

In an alternative embodiment of the invention, the same resin is selected for both the stratification resin and the adhesive resin.

In another alternative embodiment of the invention, not shown, the spacer is positioned in all the interface zones between the profile element and the composite covering, i.e., along the walls 22 and along the bridge 21. In this case, the spacer 5 can be made as a single element with a cross section having a U-shape profile.

The present invention is not limited to the embodiments illustrated and disclosed herein by way of non-limiting examples and includes all similar or equivalent embodiments thereof.

The invention illustratively disclosed herein suitably may be practiced in the absence of any element which is not specifically disclosed herein.

1. A cycle rim comprising:
a metallic profile element;
a covering made of composite material, said material comprising fibers embedded in a matrix;
said covering covering at least a portion of the metallic profile element;
at least one spacer being positioned between the profile element and the covering.

2. A cycle rim according to claim 1, wherein:
the metallic profile element comprises at least two sidewalls;
a bridge connecting the two sidewalls,
the covering comprises at least two flanks, each of the flanks covering a respective one of the two sidewalls;
the at least one spacer comprises at least two spacers, each of the two spacers being positioned between a respective one of the two sidewalls and a respective one of the two flank covering said respective one of the two sidewalls.

3. A cycle rim according to claim 1, wherein:
the spacer is in contact with the two sidewalls and the bridge.

4. A cycle rim according to claim 1, wherein:
the at least one spacer has a thickness ranging between 0.05 mm and 0.2 mM.

5. A cycle rim according to claim 2, wherein:
each of the flanks comprises outer surfaces;
a braking surface is provided on each of the outer surfaces of the flanks.

6. A cycle rim according to claim 1, wherein:
the covering is comprised of high-performance fibers.

7. A cycle rim according to claim 1, wherein:
the spacer includes a plurality of balls.

8. A cycle rim according to claim 1, wherein:
the spacer includes fibers.

9. A wheel for a cycle, said wheel comprising:
a hub;
a rim;
a plurality of spokes between the hub and the rim;
said rim comprising:
a metallic profile element;
a covering made of composite material, said material comprising fibers embedded in a matrix;
said covering covering at least a portion of the metallic profile element;
at least one spacer being positioned between the profile element and the covering.

10. A cycle comprising:
at least one wheel comprising:
a hub;
a rim;
a plurality of spokes between the hub and the rim;
said rim comprising:
a metallic profile element;
a covering made of composite material, said material comprising fibers embedded in a matrix;
said covering covering at least a portion of the metallic profile element;
at least one spacer being positioned between the profile element and the covering;
a brake comprising two brake pads;
said two brake pads being positioned and arranged to be pressed against said covering during a braking phase.
